(19) United States
(12) Patent Application Publication
(10) Pub. No.: US 2016/0263580 A1
(43) Pub. Date: Sep. 15, 2016

(54) SIZER WITH ADJUSTABLE ROLL DRUM

(71) Applicant: Joy MM Delaware, Inc., Wilmington, DE (US)

(72) Inventors: Brett Rhea, Lexington, KY (US); John C. McCarthy, Wauwatosa, WI (US)

(21) Appl. No.: 14/820,525

(22) Filed: Aug. 6, 2015

Related U.S. Application Data
(60) Provisional application No. 62/132,725, filed on Mar. 13, 2015.

(51) Int. Cl. B02C 4/30; B02C 4/32; B02C 4/08

(52) U.S. Cl. CPC B02C 4/30; B02C 4/08; B02C 4/32

(57) ABSTRACT

A sizer includes a frame defining a sizing chamber and a roll assembly positioned at least partially in the sizing chamber and supported for rotation relative to the frame. The roll assembly includes a shaft defining a longitudinal axis and configured to be driven by a motor about the longitudinal axis, an adaptor coupled to the shaft for rotation with the shaft, a cutting section removably coupled to the adaptor, and at least one insert positioned between the cutting section and the adaptor. The cutting section includes at least one cutting element positioned at a radial distance from the longitudinal axis. The at least one insert is removably coupled between the cutting section and the adaptor to modify the radial distance of the cutting element.

### CROSS-REFERENCE TO RELATED APPLICATION

This application claims the benefit of prior-filed, co-pending U.S. Provisional Patent Application No. 62/132,725, filed Mar. 13, 2015, the entire contents of which are hereby incorporated by reference.

### BACKGROUND

The present invention relates to the field of mining sizers for comminuting material e.g., minerals. Specifically, the present invention relates to a roll drum for a mining sizer.

Mining sizers (sometimes referred to as double roll crushers) typically include a pair of counter-rotating roll drums. The drums are supported for rotation on a frame. Each roll drum includes a multiple cutting elements or picks secured to the outer surface of the roll drum. The cutting elements engage oversize material to break the material and reduce it to a desired dimension. Material that is already sized to the desired dimension passes between the rotating drums. The sizer acts as a combination crusher and screen. The overlapping configuration and counter-rotating interaction of the rotating drums provides a self-cleaning function to prevent material build-up.

### SUMMARY

In one aspect, a sizer includes a frame defining a sizing chamber and a roll assembly positioned at least partially in the sizing chamber and supported for rotation relative to the frame. The roll assembly includes a shaft defining a longitudinal axis and configured to be driven by a motor about the longitudinal axis, an adaptor coupled to the shaft for rotation with the shaft, a cutting section removably coupled to the adaptor, and at least one insert positioned between the cutting section and the adaptor. The cutting section includes at least one cutting element positioned at a radial distance from the longitudinal axis. The at least one insert is removably coupled between the cutting section and the adaptor to modify the radial distance of the cutting element.

In another aspect, a sizer includes a frame defining a sizing chamber, a first roll assembly supported for rotation relative to the frame, and a second roll assembly supported for rotation relative to the frame. The first roll assembly includes a first shaft, an adaptor coupled to the first shaft for rotation with the first shaft, a first cutting section, and at least one insert positioned between the adaptor and the first cutting section. The first shaft defines a first axis and is configured to be driven by a motor in a first direction about the first axis. The first cutting section is removably coupled to the adaptor and includes at least one first cutting element positioned at a first radial distance from the first axis. The at least one insert is removably coupled between the first cutting section and the adaptor to modify the radial distance of the first cutting element. The second roll assembly includes a second shaft and a second cutting section. The second shaft defines a second axis and is positioned such that the second shaft is parallel to the first axis. The second shaft is driven about the second axis in a second direction opposite the first direction. The second cutting section includes at least one second cutting element positioned at a second radial distance from the second axis. The second roll assembly spaced apart from the first roll assembly such that the first cutting element and the second cutting element are interspersed with one another along the length of the first axis and the second axis.

In yet another aspect, a method of modifying a mean radius of a roll assembly of a mining sizer includes: providing a roll assembly including a rotating shaft, at least one adaptor coupled to the shaft for rotation with the shaft, and at least one cutting section removably coupled to the adaptor, the cutting section including a cutting element; uncoupling the cutting section from the adaptor; positioning an insert adjacent the adaptor; and re-coupling the cutting section to the adaptor such that the insert is positioned between the adaptor and the cutting section.

Other aspects of the invention will become apparent by consideration of the detailed description and accompanying drawings.

### BRIEF DESCRIPTION OF THE DRAWINGS

FIG. 1 is a perspective view of a sizer.

FIG. 2 is a top view of the sizer of FIG. 1.

FIG. 3 is an exploded view of the sizer of FIG. 1.

FIG. 4 is a partially exploded view of a roll drum.

FIG. 5 is a perspective view of a portion of an assembled roll drum.

FIG. 6 is a section view of the sizer of FIG. 2 viewed along section 6-6.

FIG. 7 is an exploded view of a portion of the roll drum of FIG. 4.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof Unless specified or limited otherwise, the terms “mounted,” “connected,” “supported,” and “coupled” and variations thereof are used broadly and encompass both direct and indirect mountings, connections, supports, and couplings.

### DETAILED DESCRIPTION

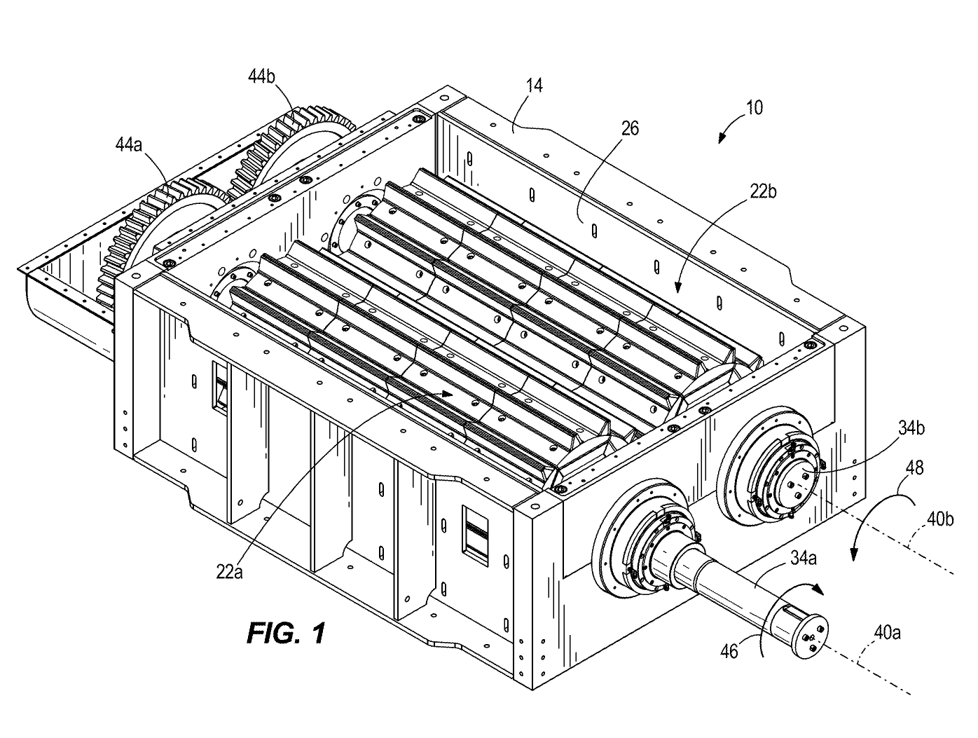

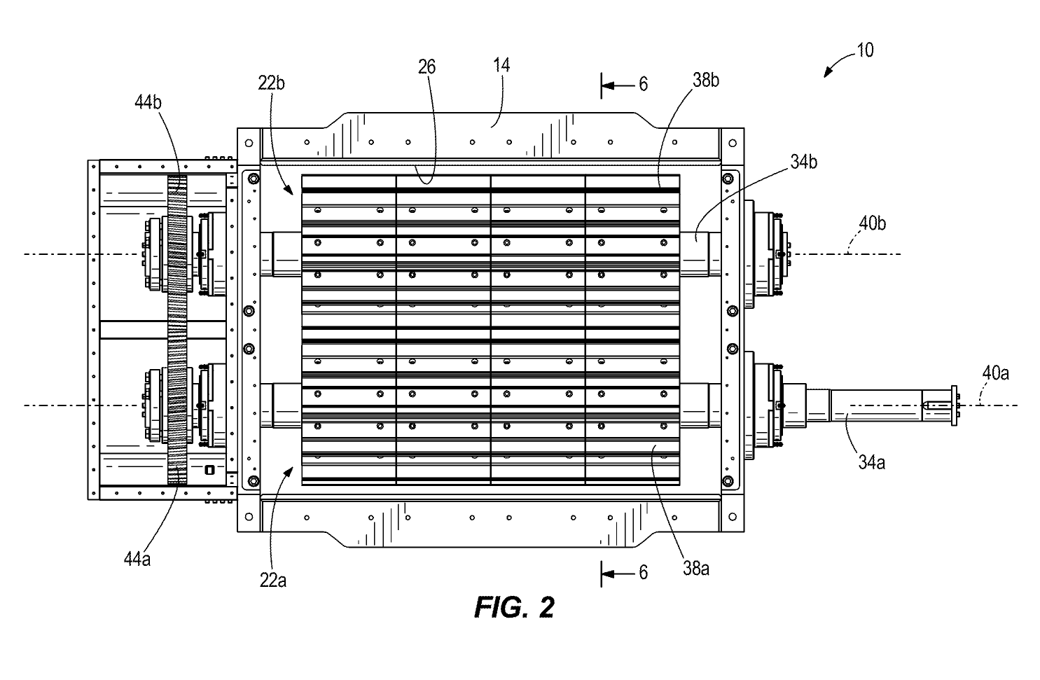

FIGS. 1 and 2 illustrate a sizer 10 including a frame 14 and roll assemblies or drums 22. As used herein, a sizer 10 may also include a roll crusher. In the illustrated embodiment, the sizer 10 includes a first roll drum 22a and a second roll drum 22b. In some embodiments, the sizer 10 may have a single roll drum 22, or it may have more than two roll drums 22. The frame 14 defines a sizing chamber 26. In the illustrated embodiment, the crushing or sizing chamber 26 has a generally rectangular shape. Material is dropped or deposited into the sizing chamber 26 to be broken apart by the roll drums 22. In the illustrated embodiment, the first roll drum 22a is driven by a motor (not shown), which may be supported adjacent the frame 14 proximate an end of the sizing chamber 26.

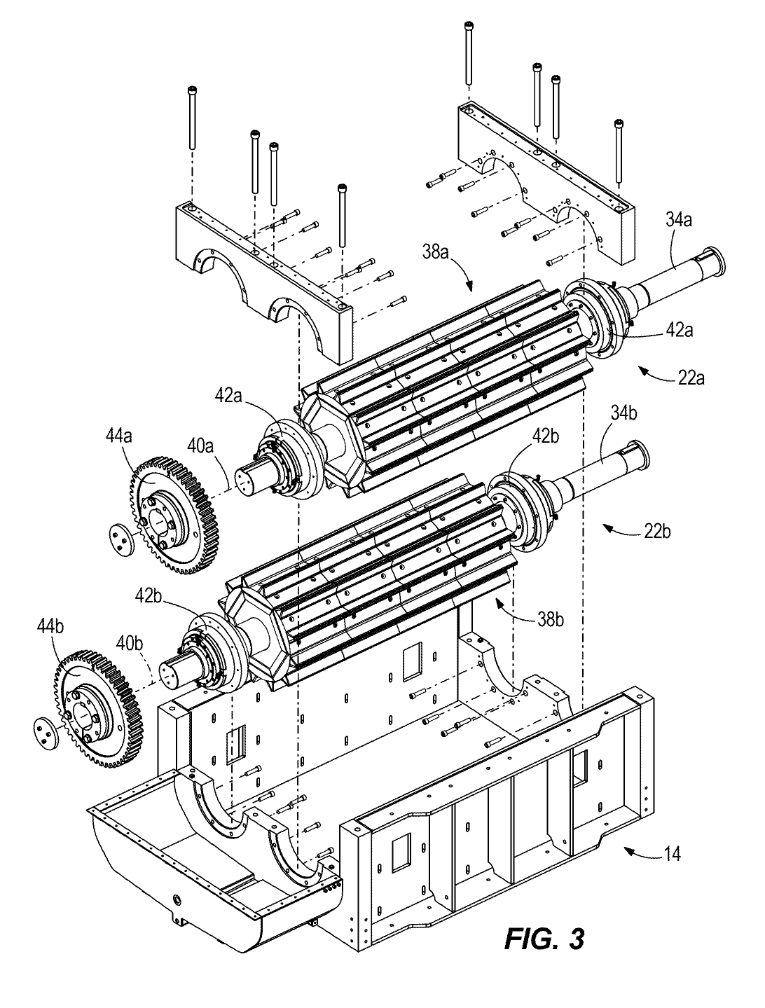

Each roll drum 22a, 22b includes a shaft 34a, 34b, respectively, extending through the sizing chamber 26. Each shaft 34 has a first end, a second end, and a crushing portion 38 positioned within the sizing chamber 26. As shown in FIG. 3, each shaft 34a, 34b includes bearing assemblies 42a, 42b supporting each end of the shafts 34a, 34b relative to the frame 14. The shafts 34 are positioned such that the axes of rotation 40a, 40b of the shafts 34a, 34b are oriented parallel to one another.

The first end of the first shaft 34a is in direct mechanical communication with the motor (not shown) in order to rotate the first roll drum 22a. As shown in FIGS. 1-3, in the illustrated embodiment, a first gear 44a is coupled to the second end of the first shaft 34a, and a second gear 44b is coupled to the second end of the second shaft 34b. The gears 44 are positioned in a gear case proximate and end of the frame 14, and the gears 44 mesh with one another. The rotation of the first shaft 34a in a first direction 46 (FIG. 1) about the first axis 40a causes the second roll drum 22b to rotate in a second, opposite direction 48 (FIG. 1) about the second axis 40b. In other embodiments, each shaft 34a, 34b may be driven by a separate motor and gear drive and are not connected to one another by gears 44. In the illustrated embodiment, the roll drums 22 are driven to rotate such that an upper portion of each drum (i.e., the portion positioned proximate the entry through which material is deposited into the sizing chamber 26) rotates toward the other roll drum 22 so that the material is urged into the space between the roll drums 22.

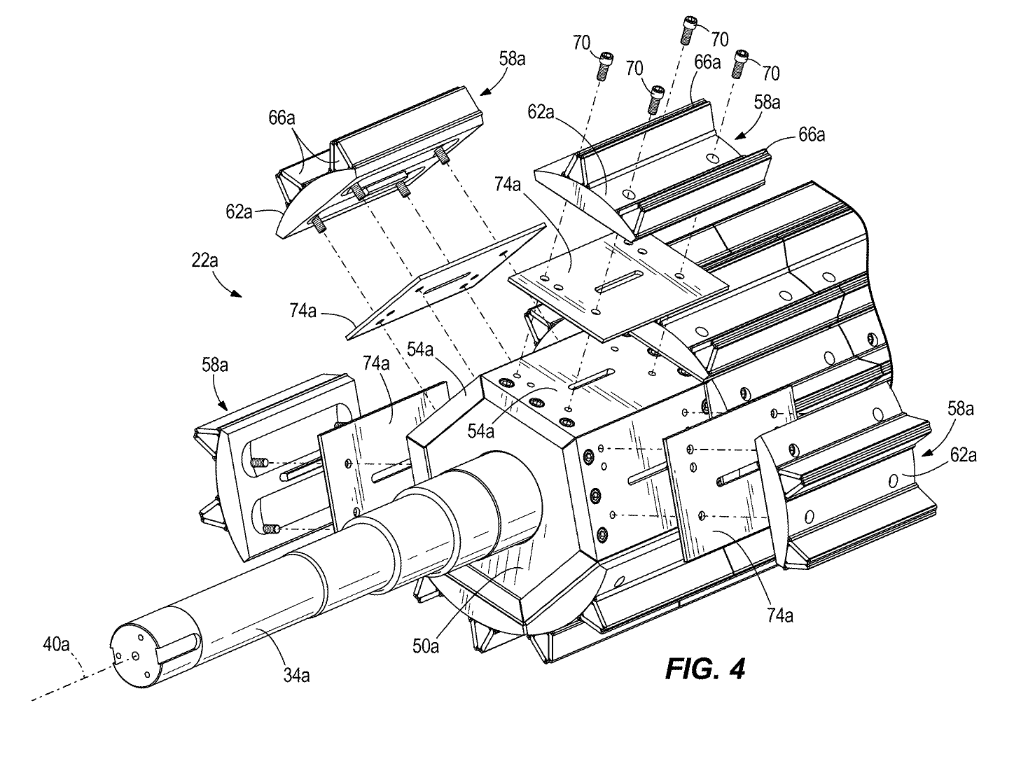

FIG. 4 illustrates an exploded view of the first roll drum 22a. However, it is understood that the second roll drum 22b may include similar if not identical features as those illustrated and described below with respect to the first roll drum 22a. As shown in FIG. 4, the crushing portion 38a of the first roll drum 22a includes webs 50a, adaptors 54a, and cutting sections 58a. The webs 50a are coupled to the first shaft 34a and spaced apart along the first shaft 34a. The webs 50 extend perpendicular with respect to the first axis 40a of the shaft 34. Although one web 50a is shown in FIG. 4, it is understood that additional webs 50a may be secured to the first shaft 34a and spaced apart along the first shaft 34a, e.g. at regular intervals corresponding to the length of the adaptor 54a.

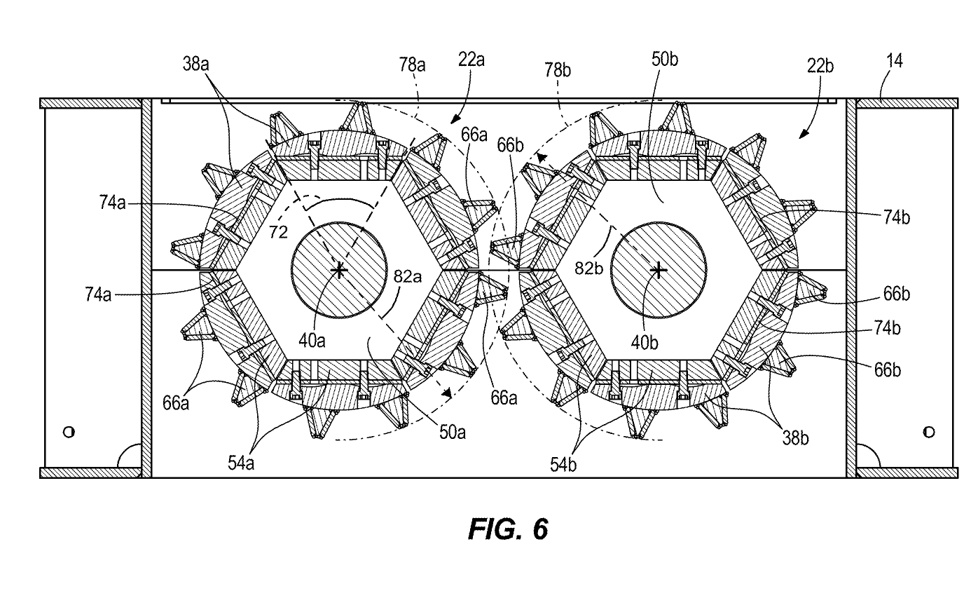

The adaptors 54a are coupled to the outer edges of the webs 50a (e.g., by fasteners), and the cutting sections 58a are removably coupled to the adaptors 54a. Each cutting section 58a may be removably coupled to one of the adaptors 54a by fasteners 70 (e.g., bolts). In the illustrated embodiment, the crushing portion 38a includes multiple adaptors 54a positioned end-to-end along the length of the crushing portion 38a, and also includes six adaptors 54a equally spaced radially around the first shaft 34a to create a hexagonal cross-section. Stated another way, each adaptor 54a in the illustrated embodiment has an equal width and extends through an angle 72 (FIG. 6) about the axis of rotation 40a of the first shaft 34a. Similarly, each cutting section 58a attached to the adaptor 54a has an equal width. In the illustrated embodiment, the angle 72 is approximately 60 degrees. In other embodiments, the angle 72 of each cutting section 58a may be between approximately 45 degrees and approximately 72 degrees. In still other embodiments, the angle 72 of each cutting section 58a may be between approximately 40 degrees and approximately 72 degrees. That is, the crushing portion 38a may have a larger or smaller mean diameter, or the crushing portion 38a may be formed with a polygonal cross-section having five sides, or may be formed having eight or more sides. In still other embodiments, fewer than five or more than eight adaptors 54a and cutting sections 58a may be used. The adaptors 54a and/or the cutting sections 58a may be formed in a different manner.

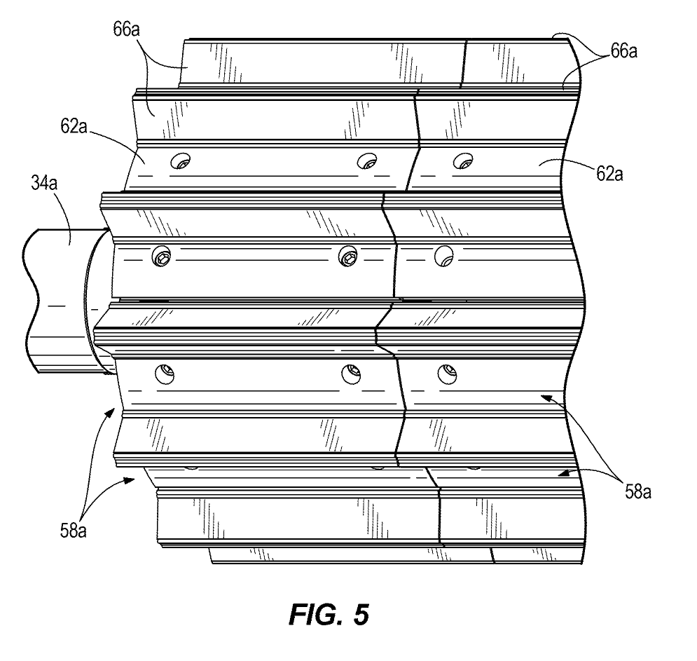

Each cutting section 58a defines an outer surface 62a and may include multiple cutting elements 66a extending from the outer surface 62a. In the illustrated embodiment, the cutting elements 66a are formed as elongated ridges extending along the length of the cutting section 58a and parallel to the axis 40a of the first shaft 34a. As shown in FIG. 5, each cutting element 66a may be aligned with a cutting element 66a of another adaptor 54a positioned adjacent in the longitudinal direction, thereby forming a continuous cutting element extending along a substantial portion of the first shaft 34a. In other embodiments, the cutting elements may be formed as multiple independent picks extending from the outer surface 62a.

Referring again to FIG. 4, the crushing portion 38a further includes inserts or shims 74a, and each shim 74a is positioned between each cutting section 58a and the adaptor 54a. In the illustrated embodiment, the shim 74a is a flat plate, and is positioned between a flat outer surface of the adaptor 54a and a flat inner surface of the cutting section 58a. Each shim 74a has holes aligned with the fasteners 70 that extend through the cutting section 58a and into the adaptor 54a. In addition, an elongated slot is positioned in a central portion of the shim 74a and oriented generally parallel to the first axis 40a. Although FIG. 4 illustrates one shim 74a positioned between each adaptor 54a and cutting section 58a, in other embodiments more than one shim 74a may be used. Also, the shims 74a may have varying thicknesses. The inclusion of the shim 74a increases the distance between the adaptor 54a and the cutting section 58a, thereby increasing the effective radius of the cutting edge or tip of each cutting element 66a relative to the axis of rotation 40a.

As shown in FIG. 6, the cutting elements 66a, 66b define an outer profile 78a, 78b of each roll drum 22. The outer profiles 78a, 78b may overlap with one another, and the roll drums 22 may be timed such that the cutting elements 66a, 66b alternate with one another. In other embodiments, the cutting elements 66a, 66b may be interspersed longitudinally with one another such that a cutting element 66 of one of the roll drums 22 is aligned with a cutting element 66 of the other roll drum 22 in a direction parallel to the axes 40a, 40b as the roll drums 22 rotate.

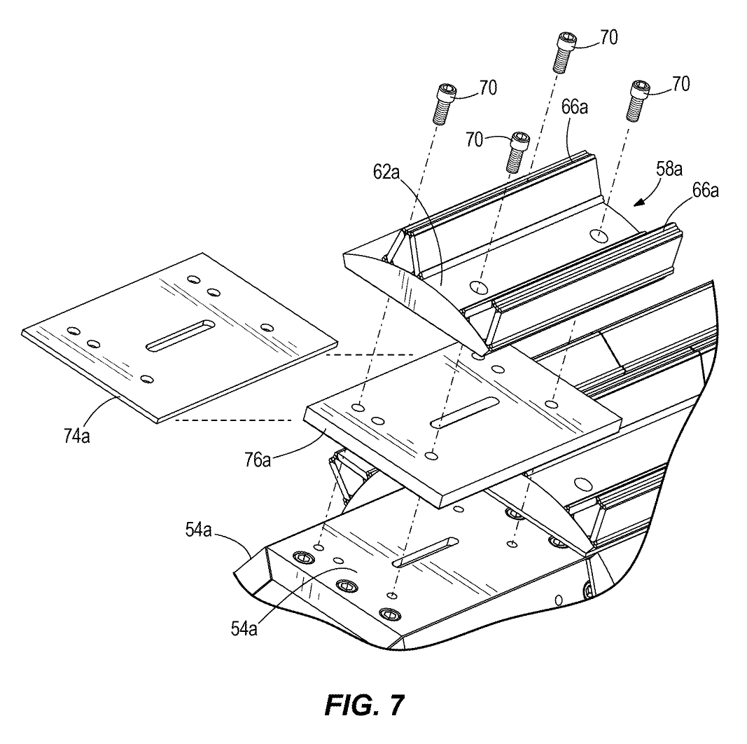

Each outer profile 78a, 78b has a mean radius 82a, 82b relative to its respective axis of rotation 40a, 40b. When referring to the diameter of the profile 78a, 78b, this dimension is sometimes referred to as the effective diameter or mean diameter of the roll drum 22a. The thickness (or in some cases, the absence) of the shim changes the radial distance of the cutting elements 66a, 66b, thereby changing the mean radius 82a, 82b. As shown in FIG. 7, the shim 74a may be replaced with a shim 76a having a greater thickness in order to increase the mean radius 82a.

By adding a shim 74a, or replacing the shim 74a with a shim 74a having a different thickness, or adding multiple shims 74a, an operator can quickly adjust the mean radius 82a, 82b or mean diameter of the crushing portion 38. For example, the operator may replace the shim 74a with a shim 74a having a larger thickness, or may add additional shims 74a between the adaptor 54 and the cutting section 58 to increase the mean diameter. The increased mean diameter results in a reduced output size for the material that is broken apart by the sizer 10. Similarly, a shim 74a may be replaced with a shim having a lesser thickness, or shim(s) 74a may be removed to decrease the mean diameter and increase the output size of material. Over time, the cutting elements 66a may wear down, but the operator can account for any reduction in the height or radial position of the cutting elements 66a by adding shims 74a to return the cutting section 58a to its original mean diameter.

The modular cutting sections 58 also permit an operator to customize the configuration of cutting elements 66a on the roll drum 22 as desired. In one embodiment, the roll drum 22 may include cutting sections having various types and/or sizes of cutting elements such that the cutting elements adjacent one end of the roll drum 22 are small and the cutting elements 66 adjacent the opposite end are large. In such a configuration, the cutting elements transition from one size to a different size along the length of the crushing portion 38.

Thus, the invention provides, among other things, a sizer with an adjustable roll drum. Although the invention has been described in detail with reference to certain preferred embodiments, variations and modifications exist within the scope and spirit of one or more independent aspects of the invention as described.

We claim:

1. A sizer comprising:
a frame defining a sizing chamber; and
a roll assembly positioned at least partially in the sizing chamber and supported for rotation relative to the frame, the roll assembly including,
a shaft defining a longitudinal axis, the shaft configured to be driven by a motor about the longitudinal axis,
an adaptor coupled to the shaft for rotation with the shaft,
a cutting section removably coupled to the adaptor, the cutting section including at least one cutting element, the cutting element positioned at a radial distance from the longitudinal axis, and
at least one insert removably coupled between the cutting section and the adaptor to modify the radial distance of the cutting element.

2. The sizer of claim 1, wherein the roll assembly includes a plurality of adaptors and a plurality of cutting sections, each of the adaptors having an adaptor width, each of the cutting sections having a cutting section width, at least some of the adaptors positioned adjacent one another radially around the shaft, each of the plurality of cutting sections removably coupled to one of the adaptors.

3. The sizer of claim 2, wherein the plurality of adaptors form a polygonal shape centered on the longitudinal axis.

4. The sizer of claim 3, wherein the plurality of adaptors form a hexagonal shape centered on the longitudinal axis.

5. The sizer of claim 2, wherein at least some of the adaptors are positioned end-to-end in a direction parallel to the longitudinal axis.

6. The sizer of claim 1, wherein the roll assembly further includes at least one web secured to the shaft, the adaptor secured to the web.

7. The sizer of claim 1, wherein the adaptor has a flat outer surface and the cutting section has a flat inner surface, wherein the insert is positioned between the flat outer surface of the adaptor and the flat inner surface of the cutting section.

8. The sizer of claim 1, wherein an outer surface of the cutting section extends through an arc about the longitudinal axis, wherein the arc is between approximately 40 degrees and approximately 72 degrees.

9. The sizer of claim 8, wherein the arc is approximately 60 degrees.

10. The sizer of claim 1, wherein the insert is a first insert, and further comprising a second insert positioned between the first insert and the cutting section to increase the radial distance of the cutting element.

11. The sizer of claim 1, wherein the insert is a first insert having a first thickness, and further comprising a second insert having a second thickness different from the first thickness, wherein the first insert is configured to be removed and replaced with the second insert.

12. A sizer comprising:
a frame defining a sizing chamber;
a first roll assembly supported for rotation relative to the frame, the first roll assembly including a first shaft, an adaptor coupled to the first shaft for rotation with the first shaft, a first cutting section, and at least one insert positioned between the adaptor and the first cutting section, the first shaft defining a first axis and configured to be driven by a motor in a first direction about the first axis, the first cutting section removably coupled to the adaptor and including at least one first cutting element positioned at a first radial distance from the first axis, the at least one insert removably coupled between the first cutting section and the adaptor to modify the radial distance of the first cutting element; and
a second roll assembly supported for rotation relative to the frame, the second roll assembly including a second shaft and a second cutting section, the second shaft defining a second axis and positioned such that the second shaft is parallel to the first axis, the second shaft driven about the second axis in a second direction opposite the first direction, the second cutting section including at least one second cutting element positioned at a second radial distance from the second axis, the second roll assembly spaced apart from the first roll assembly such that the first cutting element and the second cutting element are interspersed with one another along the length of the first axis and the second axis.

13. The sizer of claim 12, wherein the adaptor is a first adaptor, wherein the second roll assembly further includes a second adaptor and at least one second insert, the second adaptor coupled to the second shaft for rotation with the second shaft, the second cutting section removably coupled to the second adaptor, the second insert positioned between the second adaptor and the second cutting section, the second insert removably coupled between the second cutting section and the second adaptor to modify the radial distance of the first cutting element.

14. The sizer of claim 12, wherein the first roll assembly includes a plurality of adaptors positioned adjacent one another radially around the first axis, the plurality of adaptors forming a polygonal shape when viewed along the first axis.

15. The sizer of claim 14, wherein the plurality of adaptors form a hexagonal shape centered on the longitudinal axis.

16. The sizer of claim 12, wherein the first shaft includes a first end configured to be driven by the motor and a second end, the second end including a first gear secured to the first shaft for rotation with the first shaft, wherein the second shaft includes an end having a second gear engaging the first gear, such that rotation of the first shaft drives rotation of the second shaft via the engagement of the first gear and the second gear.

17. The sizer of claim 12, wherein the first cutting section extends through an angular range about the longitudinal axis, wherein the angular range is between approximately 40 degrees and approximately 72 degrees.

18. The sizer of claim 17, wherein the angular range is approximately 60 degrees.

19. The sizer of claim 12, wherein the insert is a first insert, and further comprising a second insert positioned between the first insert and the cutting section to increase the radial distance of the cutting element.

20. The sizer of claim 12, wherein the insert is a first insert having a first thickness, and further comprising a second insert having a second thickness different from the first thickness, wherein the first insert is configured to be removed and replaced with the second insert.

21. A method of modifying a mean radius of a roll assembly for a mining sizer, the method comprising:
providing a roll assembly including a rotating shaft, at least one adaptor coupled to the shaft for rotation with the shaft, and at least one cutting section removably coupled to the adaptor, the cutting section including a cutting element;
uncoupling the cutting section from the adaptor;
positioning an insert adjacent the adaptor; and
re-coupling the cutting section to the adaptor such that the insert is positioned between the adaptor and the cutting section.

22. The method of claim 21, wherein positioning the insert includes positioning a first insert having a first thickness, further comprising removing the first insert and positioning a second insert adjacent the adaptor, the second insert having a second thickness greater than the first thickness.

23. The method of claim 22, wherein removing the first insert includes uncoupling the cutting section from the adaptor, and further comprising, after positioning the second insert adjacent the adaptor, re-coupling the cutting section to the adaptor such that the second insert is positioned between the adaptor and the cutting section.
